(19) United States
(12) Patent Application Publication
(10) Pub. No.: US 2005/0189802 A1
(43) Pub. Date: Sep. 1, 2005

(54) School bus occupant restraint passenger seat

(76) Inventors: Patrick J. Mattes, Yoder, IN (US); Erik K. Nelson, Woodburn, IN (US); Thomas R. Graham, Fort Wayne, IN (US); Erik C. Wilson, Decatur, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/065,556

(22) Filed: Feb. 24, 2005

Related U.S. Application Data
(60) Provisional application No. 60/548,032, filed on Feb. 26, 2004.

(51) Int. Cl. B60N 2/42

(52) U.S. Cl. 297/216.13

(57) ABSTRACT

A vehicle passenger seat mixed passive/active occupant restraint provides a two element seat back frame. A first frame element provides for energy absorption from a seat belt fitted to a passenger in the vehicle passenger seat. The second frame element absorbs energy from an unrestrained passenger impacting thereon. The first frame element may be mounted forward from, or nesting, the second frame element.

### PRIORITY CLAIM

This application claims priority from provisional application Ser. No. 60/548,032 filed 26 Feb. 2004.

### BACKGROUND OF THE INVENTION

1. Technical Field

The invention relates to passenger seat occupant restraints and more particularly to a passive restraint built into seat backs.

2. Description of the Problem

Three point seat belt systems have long been used in automobiles. Three point seat belt systems combine a lap belt with a single upper torso belt crossing a person's chest from over one shoulder to a point of connection with the lap belt on the other side of the wearer's body, usually adjacent the location of a buckle located low on, or along side of, the seat.

Designers of school buses face certain difficulties in providing three point seat belts in buses. First, United States' federal regulations for passive restraints (i.e. those effective with respect to passengers whether wearing a seat belt or not) require that the rear side of a seat provide an impact barrier that bends or deforms for passengers sitting behind that seat. These requirements are codified at 49 CFR Sect. 571.222 (FMVSS 222).

The code specifies a passive restraint system for passengers, but does not require active restraints such as a two point lap belt or three point lap/torso combination system. The passive restraint system requirements in effect provide that a compartment exist which contains an unbuckled passenger in the event of sudden deceleration. This has been met by making the back of the seat in front of a potentially unbuckled passenger into a deformable impact cushion. Although two point belt systems are offered on buses, designers need to consider three-point seat belts where requested by local or State governments, or by action groups. Although these belts are not required by federal law or regulation, when installed they become subject to federal regulations. These requirements provide that the belts be installed in such a way as to limit a buckled passengers forward movement. The pertinent sections of the federal code are 49 CFR Sects. 571.209 and 210 (FMVSS 209 and FMVSS 210).

The conflict in requirements arises from the need to deal both with restrained and unrestrained passengers simultaneously. In a rapid deceleration event a passenger in a forward seat may be buckled in while a passenger in the seat immediately aft from the buckled in passenger may not be buckled in. With the aft passenger being spaced from the back of the forward seat, the initial response of the restraint systems occurs as a reaction to the buckled passenger moving forward in his seat and thereby applying tension on the buckled seat belt and at its attachment point to the seat frame. This can result in the belt pulling on the seat back in the forward direction and possibly reducing the strength of the seat back to meet a rear impact by the rear seat passenger. The reduction in seat back strength due to the pull on the three-point seat belt, which meets the FMVSS 210 requirement, may reduce the ability of the seat back to meet the FMVSS 222 requirements.

Recent school bus seat designs have been developed that involve a movable inner seat or interior reinforcement tower for the mounting of the three point seat belts and a separate seat back portion (or frame) for the absorption of the impact of an unbuckled passenger. The movable inner seat (or frame) is inserted into a recess within an outer, positionally fixed, but deformable, seat back. The outer seat back is then designed to deform in order to comply with FMVSS 222. Such designs are disclosed in U.S. Pat. Nos. 6,123,388, and 6,485,098. The concept of a seat inserted within a seat was also disclosed in U.S. Pat. No. 4,784,352 for an aircraft ejection seat.

### SUMMARY OF THE INVENTION

The invention provides two-element seat back frames for use with three point seat belts. The seat back frame is formed with a first frame element providing an attachment point for the three point seat belt shoulder harness and for absorbing energy from the belt by deforming and a relatively less deformable second frame element for absorbing the impact of a unrestrained passenger hitting the seat back from behind.

The vehicle passenger seat restraint system comprises a seat belt, a base passenger seat frame for mounting in a vehicle, a seat back depending from the base passenger seat frame, and first and second upright seat back frames, the first upright seat back frame providing for absorbing loading applied to the seat belt by deforming and the second seat back frame providing for receiving loading by rear impacts thereto. A first embodiment further provides the second seat back frame being nested within the first upright seat back frame with the sides of the second seat back frame lying to the inside of the sides of the first seat back frame and the top of the second seat back frame being positioned below the top of the first seat back frame. A second embodiment provides the first upright seat back frame being located directly forward from the second seat back frame across the back of the base passenger seat frame and is designed to deform under loading to a greater degree than the second seat back frame.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of a school bus.

FIG. 2 is a front quarter perspective view of a school bus seat modified to handle a three point seat belt.

FIG. 3 is a partially cut away view of a school illustrating operation of various embodiments of the invention.

FIG. 4 is a cross sectional view of a first nested deformable back embodiment of the invention.

FIG. 5 is rear quarter view of the nested deformable back embodiment of FIG. 4.

FIG. 6 is a cross sectional view of a second embodiment of the invention.

### DETAILED DESCRIPTION OF THE INVENTION

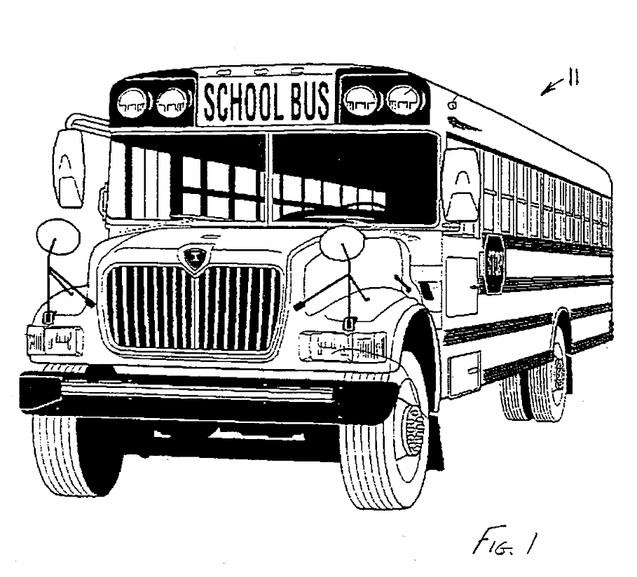

Referring to FIG. 1 a school bus 11 is illustrated. As is well known, school buses are conventionally equipped with rows of forward facing seats for passengers. These seats must meet impact federal regulations relating to unrestrained passengers. If equipped with three point seat belts the seat belts must also meet certain federal regulations.

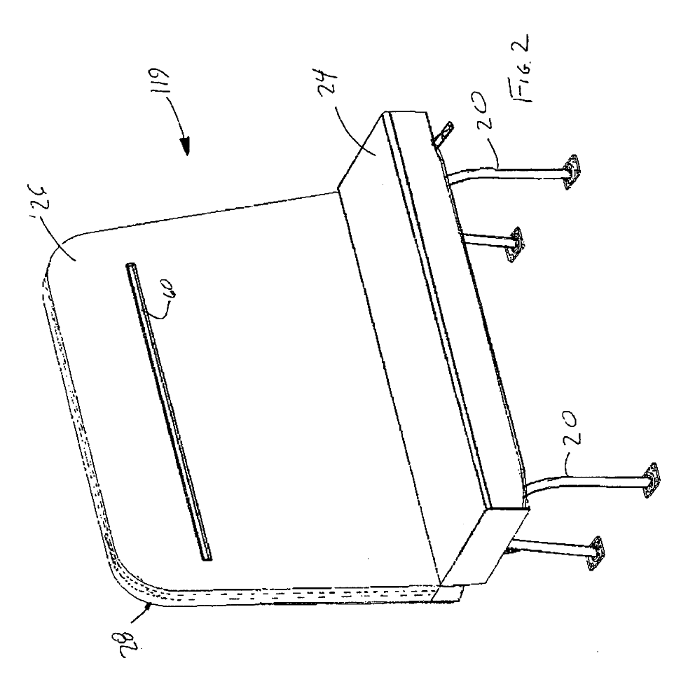

FIG. 2 illustrates school bus seat 119. Seat 119 is supported from a floor by risers 20 and includes a seat cushion 24 and a back cushion 26. Back cushion 26 is supported on a rear frame 28. A slot 60 through back cushion allows fitting of a torso belt where a three point seat belt is incorporated with seat 119 and anchored to the seat frame.

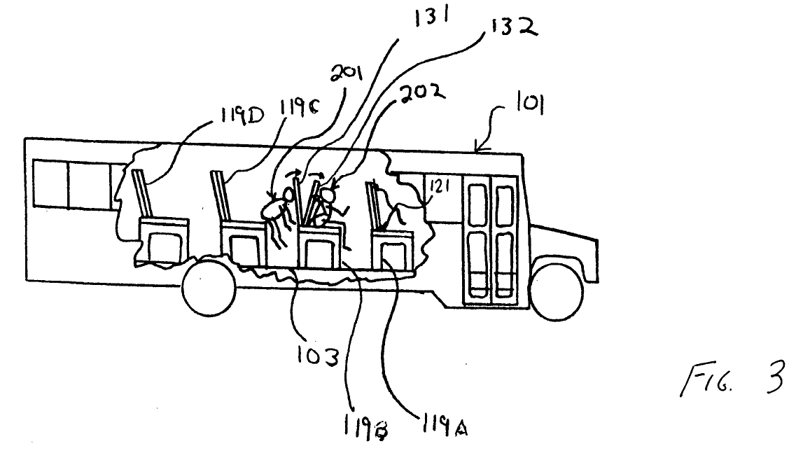

Referring to FIG. 3, operation of the invention is illustrated. School bus 11 includes a plurality of seats 119A-D installed on bus floor 103, two of which 119A-B are equipped with 3-point seat belts 121. It is not anticipated that vehicles would be sold where only a few of the seats are equipped with seat belts. The illustration of a bus so equipped is intended only for purposes of illustration. The torso belt portion of seat belt 121 plays out from an opening in the seat backs from a point anchoring it to the seat back frame or in such a way that a sudden, strong extractive force applied to the belt is transferred to the seat back frame. Seat belt 121 operates to restrain passengers who have buckled into the seats such as passenger 202 in seat 119B upon a sudden deceleration. An unrestrained passenger 201 is shown coming forward from seat 119C from directly behind and into the back of seat 119B.

With passengers 202 and 201 having been thrown forward in the bus, passenger 202 is restrained by a seatbelt 121 pulling a front portion 132 of seat 119B forward. Under the impact of passenger 201, seat back 131 has also tilted or deformed forward but to a lesser degree than front portion 132. Deformation of seat back 131 is limited to about a 17 degree change from its initial rake, a lesser degree of change than is allowed the front portion 132.

The invention provides for sequential occupant protection for both restrained and un-restrained passengers and works to meet the requirements both FMVSS 222 and 210 simultaneously.

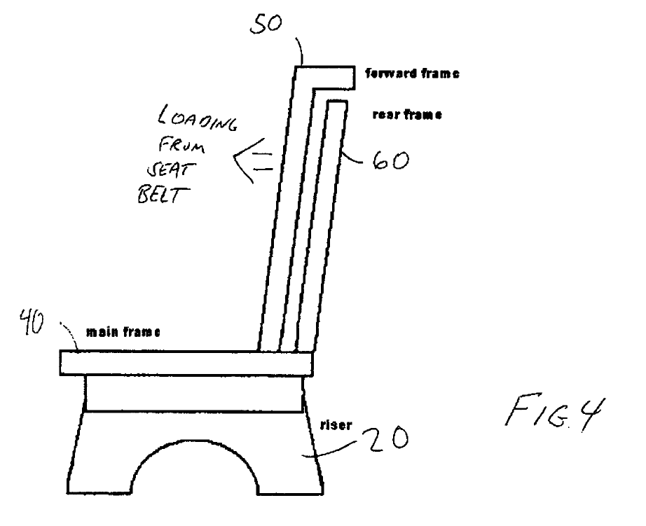

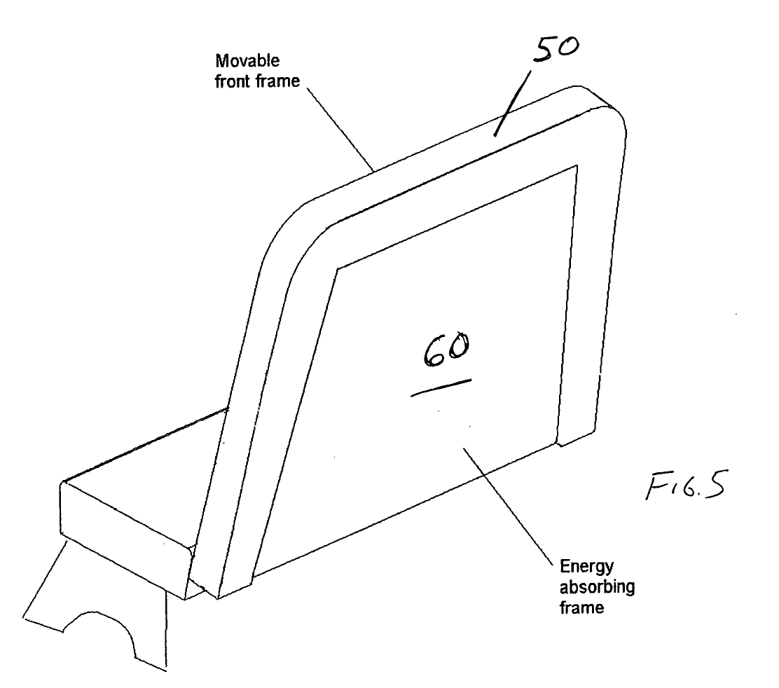

Referring to FIGS. 4 and 5 a first embodiment of this invention provides increased initial contact and hence resistance area to a rear seat passenger in a nested two piece seat. A forward frame 50 mounted on a main frame 40 provides an attachment point for a seat belt. A rear frame 60 is made to deform under rear impact, as effectively required by federal regulations and as taught in the art, to absorb the impact of a rear passenger. The greater initial resistance of the rear frame 60 prevents spurious forward frame 50 movement. Rear frame 60 of seat 119 is designated to absorb energy loadings to achieve specific sections of FMVSS 222. Forward frame 50 of the seat 119 is designated to absorb the energy loadings to achieve FMVSS 210. Rearward frame 60 handles the loads from the rear (for energy absorption of occupants seated behind) and is nested within the forward portion of the seat (for energy absorption of belted occupants) to reduce overall seat thickness. The rear seat back frame 60 (FMVSS 222) resides within the forward seat back frame 50 (FMVSS 210) at the top and along the sides in normal usage to minimize total seat back thickness maintain seat-row capacity in buses. When subjected to a sudden vehicle deceleration not exceeding a first threshold level (such as may occur in hard braking or in a very minor accident—less than 2.0 G loading), the 3-point restraint system functions to keep the occupant in position without other components of the seat entering into any of the designed energy-absorption modes. When subjected to a sudden vehicle deceleration exceeding the first threshold (a moderate to severe accident—approx 2.0 G loading and higher) the 3-point restraint systems functions to keep the occupant in position, but allows for energy absorption to occur in the seat frame members 50, 60. The forward frame 50 (FMVSS 210) absorbs the loading in the 3-point belt system through metal deformation, leaving the rear frame 60 (FMVSS 222) in position in the case any occupants seated behind are not restrained. This method of sequential occupant protection for both restrained and un-restrained passengers meets the requirements of both FMVSS 222 and 210 simultaneously, and maintains minimum seat-back thickness which allows seats to maintain seat spacing requirements set forth by local and state government.

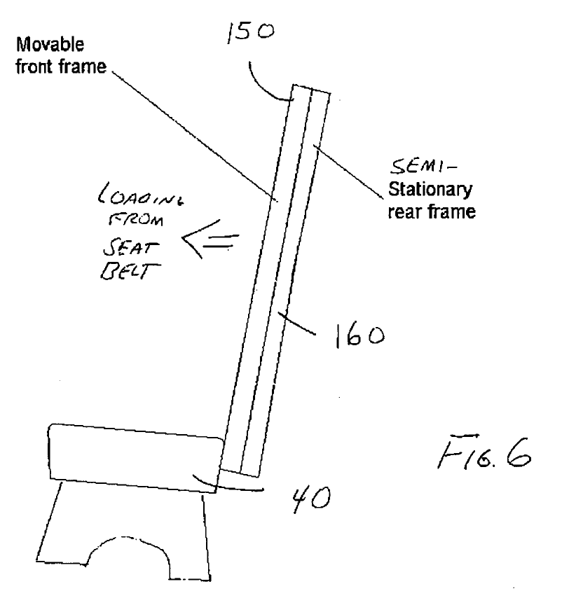

Referring to FIG. 6 a second embodiment of this invention provides for reduced resistance of the front frame 150 of the seat compared to the rear frame 160 of the seat. Rear frame 160 of the seat back is designated to absorb energy loadings to achieve specific sections of FMVSS 222. A front portion 150 of the seat back is designated to absorb the energy loadings to achieve FMVSS 210. The (forward frame 150) handles the loads of the belted occupants, whereas the rear frame 160 handles the energy absorption of any unbelted occupants seated behind. The forward seat back frame 150 is disposed just forward of the rear seat back frame 160 in normal usage. This accommodates situations where forward seat back frame and rear seat back frames cannot be nested for maintaining minimal seat back total thickness. When subjected to a sudden vehicle deceleration of minimal level (such as hard braking or very minor accident—less than 2.0 G loading) the 3-point restraint system functions to keep the occupant in position without other components of the seat entering into any of the designed energy-absorption modes. When subjected to a sudden vehicle deceleration of a more moderate level (moderate to severe accident—approx 2.0 G loading and higher) the 3-point restraint systems functions to keep the occupant in position, but allows for energy absorption to occur in the seat back and frame members. The forward seat back frame 150 absorbs the loading in the 3-point belt system by rotating or translating forward to a given distance, then be halted via a strap, web, or cable and allowing the retractor and webbing mechanisms to absorb the remaining energy. This rotation or translation for the forward seat back portion is in place to allow for the rear seat back portion 160 to be deformed to absorb FMVSS 222 energy criteria for unbelted occupants seated behind this seat, as in bus seating arrangements. This method of sequential occupant protection for both restrained and un-restrained passengers meets the requirements of both FMVSS 222 and 210 simultaneously.

While the invention is shown in only two of its forms, it is not thus limited but is susceptible to various changes and modifications without departing from the spirit and scope of the invention.

1. A vehicle passenger seat restraint system comprising:
a seat belt;
a base passenger seat frame for mounting in a vehicle;
a seat back depending from the base passenger seat frame; and
first and second upright seat back frames, the first upright seat back frame providing for absorbing loading applied to the seat belt by deforming and the second seat back frame providing for receiving loading by rear impacts thereto.

2. The vehicle passenger seat restraint system as set forth in claim 1, wherein:
the second seat back frame is nested to the top and both sides within the first upright seat back frame.

3. The vehicle passenger seat restraint system as set forth in claim 1, wherein:
the first upright seat back frame is located directly forward from the second seat back frame across the back of the base passenger seat frame and is designed to deform under loading to a greater degree than the second seat back frame.

4. A vehicle passenger seat comprising:
a base frame;
a two part seat back frame supporting both passive and active occupant restraint;
a first seat back frame element provides for absorbing energy from a seat belt attached with respect to the first frame element;
a second seat back frame element for absorbing energy from an unrestrained passenger impacting thereon; and
the first seat back frame element being attached to the base frame so as to deform forward under loading from the seat belt before, and to a greater degree, than the second seat back frame element does under loading by an impacting passenger.

5. The vehicle passenger seat of claim 4, further comprising:
the first seat back frame element being mounted on the base frame forward from a mounting for the second seat back frame element.

6. The vehicle passenger seat of claim 4, further comprising:
the second seat back frame element being mounted on the base frame within the first seat back frame element.
